(19) United States
(12) Patent Application Publication
(10) Pub. No.: US 2008/0028593 A1
(43) Pub. Date: Feb. 7, 2008

(54) Method for producing a cohesive connection, and flowmeter

(75) Inventors: Rene Friedrichs, Rosdorf (DE); Frank Kassubek, Rheinfelden (Baden) (DE); Kuno Hug, Heidelberg (DE); Jorg Gebhardt, Mainz (DE); Wolfgang Waldi, Nussloch-Maisbach (DE); Reinhard Steinberg, Worbis (DE); Lothar Deppe, Gottingen (DE); Steffen Keller, Karlsruhe (DE); Gunter Petri, Sandhausen (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/882,709

(22) Filed: Aug. 3, 2007

(30) Foreign Application Priority Data
Aug. 5, 2006 (DE) 10 2006 036 702.2

(51) Int. Cl. B23P 11/02

(52) U.S. Cl. 29/447

(57) ABSTRACT

The invention relates to a method for producing a cohesive connection between a tube and a built-in housing, in particular for fixing a measuring tube in the housing of a flowmeter, according to the preamble of patent claims 1 and 4. In order to ensure a reliable connection between the components in this case so that a reliable measurement using the Coriolis mass flowmeter is possible, the invention proposes that ring or tube sections are first of all applied to the measuring tube at least one of said connection locations and are connected to the measuring tube by means of a hard solder connection and, in the region of the ring or tube sections which have been soldered on, the latter are then welded to the housing or housing flanges.

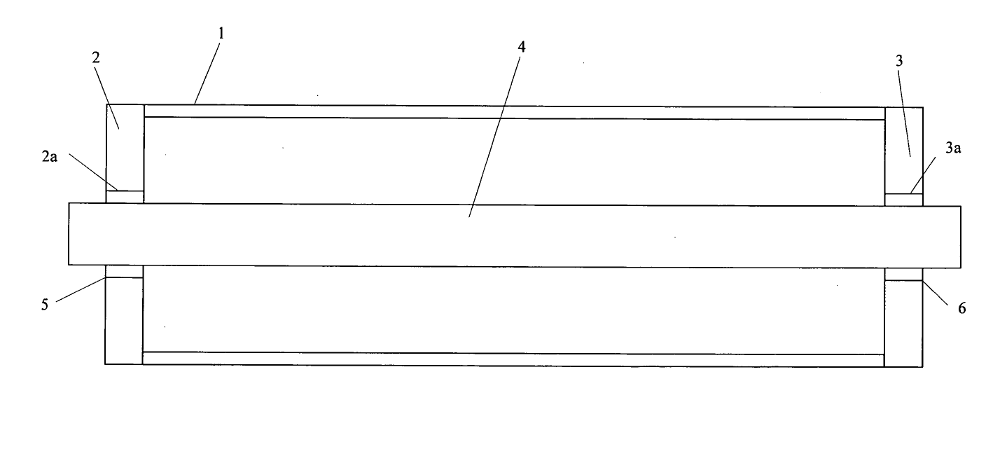

### TECHNICAL FIELD

Method for producing a cohesive connection between a tube and a built-in housing, in particular for fixing a measuring tube in the housing of a flowmeter, according to the preamble of patent claim 1.

### BACKGROUND INFORMATION

Flowmeters differ in terms of their designs which are dependent on that measuring effect on which they are based. Use is often made of so-called Coriolis meters in which the measuring medium is passed through a bent measuring tube which causes deflection on the basis of the flow, said deflection then being measured and the flow being calculated from the latter and being displayed.

This design also gives rise to the stipulation that the deflection of the measuring tube remains limited to the selected measuring path. Since vibrations are generated by the deflection, this vibration should remain vibrationally or mechanically isolated to the length of the measuring path without dissipating energy outward.

However, these connections between the measuring tube and the housing are also subject to the effects of changing temperatures. On account of differently selected materials, this naturally results in mechanical stresses on account of different coefficients of thermal expansion.

US 2003/0084559A1 discloses a connection of this type, in which a shrink-mounting method is selected. That is to say the materials are dimensioned relative to one another so as to produce a shrink-fit, that is to say the material is thermally expanded and then shrunk onto the corresponding component by cooling.

However, a procedure of this type cannot actually be used for an application as in the present case.

### SUMMARY

Therefore, the invention is based on the object of ensuring a reliable connection between the components so that a reliable measurement using the Coriolis mass flowmeter is possible.

According to the invention, the object which has been set is achieved, in the case of a method of the generic type, by means of the characterizing features of patent claim 1.

Further advantageous refinements of the method according to the invention are specified in the dependent claims.

The essence of the invention according to the method is that ring or tube sections are first of all applied to the measuring tube at said connection locations and are connected to the measuring tube by means of a hard solder connection and, in the region of the ring or tube sections which have been soldered on, the latter are then welded to the housing or housing flanges or to the supporting frame.

In this case, the measuring tube can be welded either in a housing or in a supporting frame using this connecting technique. In this case, the housing constitutes a more or less closed form, whereas a supporting frame may be an open or partially open arrangement which is in the form of a framework and to which or into which the measuring tube can be welded.

In general, this connecting technique can be used to connect attachments such as eccentric masses or actuator magnets to the measuring tube.

In this case, the tube sections or rings are thus fixed to the measuring tube by means of a hard solder connection and are fixed in the housing by means of a welded connection. Using these two different connecting techniques in this case and thus avoiding connecting the measuring tube to the housing directly has the advantage that, during the respective cohesive connecting techniques, less deformation is produced in the components and, after the hard soldering and the subsequent welding have been carried out, no mechanical stresses are thus frozen by cooling.

Another advantageous refinement states that the welding can be effected using electron beam welding. The introduction of thermal energy is thus minimal, with the result that the welding temperatures of more than 1100 degrees Celsius which usually otherwise occur and naturally change the shape of the measuring tube and housing to a considerable extent are avoided. In the case of this connecting technique, high fatigue fracture endurance of the measuring tube fixing is achieved using a hard solder fillet weld or the hard solder fillet weld used.

In another advantageous refinement of the invention, the tube sections or rings are provided with slots which run in a parallel or oblique manner in the axial direction such that said tube sections or rings can expand during the hard soldering during which a relatively large amount of heat is introduced. This then has the advantage that the solder gap between the tube section or ring and the measuring tube does not change its gap width when soldering along the solder seam.

The effect is that the predefined solder gap always remains the same during soldering and is not contorted or moved or changed in terms of its dimensions along the solder seam as a result of heating. This is a considerably important aspect for creating a stress-free and reproducible hard solder connection.

In terms of the Coriolis mass flowmeter, the invention consists in that at least one ring which is fixed to the tube by means of a hard solder connection and is fixed to the housing by means of welding is arranged at each connection location between the measuring tube and the housing.

If this connection is stress-free, destructive influences on the isolated vibration are avoided, thus also resulting in an overall improvement in the measurement result of the device by virtue of this important technical measure.

Another advantageous refinement states that the ring has an external shape or external contour which differs from the rotational symmetry. This makes it possible to predetermine, for example, a particular installation position which, during assembly, is predefined only in one possible desired installation position as a result of this contour-based adaptation.

Another advantageous refinement provides for the relative desired position between the tube and the ring to be formed by integrally formed sections which engage in one another in a complementary manner between the ring and the attachment and between the ring and the measuring tube. As a result of this complementarity, the desired installation position which is based on the rotational position is unmistakably defined in a simple manner.

### BRIEF DESCRIPTION OF THE DRAWINGS

The invention is illustrated in the drawing and is described in more detail below.

### DETAILED DESCRIPTION

The FIGURE shows a diagrammatic illustration of only the affected components. The housing 1 with two lid or flange parts 2 and 3 as well as a tube 4 or a plurality of transverse connections between the flanges 2 and 3 can thus be seen. The measuring tube 4 is then introduced between the two end parts.

In this case, annular tube sections 5 and 6 have previously been fitted to the measuring tube 4 using a hard solder connection. In this region, the measuring tube is then pushed onto the flange or housing parts or through the openings 2a and 3a provided there and the rings 5 and 6 are then welded to the flanges 2 and 3 by means of electron beam welding.

To be precise, the hard soldering is carried out at the connecting area between the measuring tube 4 and the rings 6 and 5, while the connecting areas between the ring 5 and 6 and the flanges 2 and 3 are connected to one another by means of welding. In this case, it is also possible, in one simple design, for the rings to be directly welded to the housing, that is to say without separate flanges.

A connection in which no mechanical stresses are frozen is thus produced. In addition, the annular tube sections 2 and 3 can be provided with slots in the axial direction in order to achieve the effect described above.

In this case, it is important for the slots to thus run in such a manner that at least one axial component which is different from zero is present. That is to say the slot can run in an entirely axial manner or else obliquely. In the latter case, the axial components should at least not become zero.

This above-described favorable effect is thus retained during soldering.

### LIST OF REFERENCE SYMBOLS

1. Housing
2. Flange part
3. Flange part
4. Measuring tube
5. Tube section
6. Tube section
2a 3a Openings

1. A method for producing a cohesive connection between a measuring tube and the housing parts or a supporting frame and/or attachments of a Coriolis mass flowmeter, wherein ring or tube sections are first of all applied to the measuring tube at least one of said connection locations and are connected to the measuring tube by means of a hard solder connection and, in the region of the ring or tube sections which have been soldered on, the latter are then welded to the housing or housing flanges.

2. The method as claimed in claim 1, wherein the welding is effected using electron beam welding or laser welding or another welding technology with minimum introduction of heat.

3. The method as claimed in claim 2, wherein the tube sections or rings are provided with slots which run in a parallel or oblique manner in the axial direction in such a manner that said tube sections or rings can expand during the hard soldering during which a relatively large amount of heat is introduced.

4. A Coriolis mass flowmeter having at least one measuring tube and a housing in which the measuring tube is fixed, wherein at least one ring which is fixed to the tube by means of a hard solder connection and is fixed to the housing by means of welding is arranged at each connection location between the measuring tube and the housing.

5. The Coriolis mass flowmeter as claimed in claim 4, wherein the ring is provided with slots in such a manner that it has at least one axial component which differs from zero.

6. The Coriolis mass flowmeter as claimed in claim 1, wherein the ring has an external shape or external contour which differs from the rotational symmetry.

7. The Coriolis mass flowmeter as claimed in claim 6, wherein the relative desired position between the tube and the ring is formed by integrally formed sections which engage in one another in a complementary manner between the ring and the attachment and between the ring and the measuring tube.
